(19) United States
(12) Patent Application Publication
(10) Pub. No.: US 2006/0247823 A1
(43) Pub. Date: Nov. 2, 2006

(54) Machine for distributing articles and management system thereof

(76) Inventor: Michel Boucher, Rimouski (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/349,246

(22) Filed: Feb. 8, 2006

Related U.S. Application Data
(63) Continuation-in-part of application No. 10/608,501, filed on Jun. 30, 2003, now abandoned.

(30) Foreign Application Priority Data
Jun. 28, 2002 (CA) 2,391,599

(51) Int. Cl. G06F 17/00

(52) U.S. Cl. 700/241

(57) ABSTRACT

A computerized vending machine comprising a micro-controller, a network interface and a large touch screen is provided. The machine is further part of a larger networked system. The system is administrated with the use of a computer network linked by modem or other communication means, comprising a server and its database, administration and communication software. The vending machines are equipped with computer systems allowing for remote inventory management and methods to put products on the market which are offered via a vending machine including medical or other supplies. The display screen acts as interface between a user and the machine and can also be used for multimedia presentation such as advertisement.

### FIELD OF INVENTION

The present invention relates to vending machines. More particularly, the present invention relates to a vending machine which is interfaced via a large touch screen adapted to display multimedia content. The invention also relates to a computerized system which allows local and remote operations on the machine and inventory management of the products sold by the machine or via the machine.

### BACKGROUND OF THE INVENTION

On top of medical care given in hospitals or in clinics, patients require a large quantity of medical supplies during their treatments. These supplies, such as bandages, crotches, certain everyday drugs and many other article related to surgical procedures, require the use of a strict and controlled inventory management system in order to prevent abuses and/or unnecessary expenses. Fitzgerald (U.S. Pat. No. 5,638,985) and Shoenfeld (U.S. Pat. No. 6,223,934) propose systems using vending machines allowing the automatic control of the items provided to the users, but the inventory management is always done on the site where the vending machine is located.

The advent of computers has made it possible to offer a permanent control of the inventory management in the sales process involving vending machines with the use of centralized signals sent to persons responsible for the proper operation of the vending machines. Based on this, McGrady et al. (U.S. Pat. No. 5,848,593 et U.S. Pat. No. 5,912,818) developed a vending machine linked to a local network allowing the control of the products given to the users by using a database. Those inventions have permitted a better management control of the medical inventory and have offered the possibility to do the follow-up of the patients with respect to their treatments with the help of different terminals connected to the network.

However, the management of such vending machines requires an inventory management system which is flexible with regards to the time of the day, to the locations and to its different users, on top of allowing a bi-directional exchange of information bearing electronic signal between an administrator computer terminal and a vending machine, through a communication network, in an interactive manner.

Moreover, the advent of computer systems has also permitted the integration of novel features to vending machines. Thus, smaller, faster and more powerful computers are now able to process larger amount of information and can control a larger array of hardware devices. Prior art vending machines generally comprise a small seven segments or LCD screen to display information such as price, entry code and the like. However, the quantity of information displayed is usually extremely limited due to the small size of the screen. It is thus impossible to use the display screen to obtain a global view of the inventory, to display information about the product to be sold or even to display advertising and other similar presentation. Also, some people, for example, elderly people, may have difficulties in reading prior art screens.

The present invention thus introduces a novel vending machine which further integrates a large display screen. The screen can be used to display information about the content of the vending machine or about each product. The screen can also be used by technicians and by customers as a more user-friendly touch-screen interface to interact with the machine. The screen can even be used to display advertisements.

The machine of the present invention also includes a network interface which allows the machine to be connected to a network.

Furthermore, the present invention introduces a management system for vending machines allowing the system administrators, at any time of the day, to automatically and remotely manage all the functionalities of vending machines integrated in the network, with the help of a software installed in the computer terminals of the administrators and in the vending machines in the network.

### SUMMARY OF THE INVENTION

This invention thus comprises many inventive contributions in the vending machine field. By integrating a micro-controller in the vending machine, it is possible to add a plurality of hardware devices such as large multimedia screen, barcode reader, network interface and other interface ports to allow the connection of further devices (media player, keyboard, speakers, etc.).

Thus, according to a first aspect of the present invention, the vending machine comprises a micro-controller or other similar processing devices, such as a CPU, which controls memory storage means (e.g. hard-drive, flash memory, etc.), a preferably large multimedia display screen, a network interface and a payment module. The micro-controller may also be connected to a series of input and/or output ports (e.g. USB, serial port, parallel port, etc.).

By providing a network interface to all the vending machines, it is possible and preferable to integrate all the machines in a network which is also linked to a central server and administrative remote computers which comprise management software. The present invention will thus allow an administrator, remotely located from the machine, to remotely access and manage one or a plurality of machines via the network.

Also, each machine will also be able to send messages and/or requests to the administrators via the network. Furthermore, by adding a phone interface to the machine, a direct communication could be initiated from the user of the machine directly to the administrator.

According to another aspect of the present invention, the multimedia screen of the machine is a touch screen which is reactive to physical contact. The touch screen may thus be used as a virtual keyboard, using graphical representations of buttons, during the selection process.

According to another aspect of the present invention, the management system offers a remote ejection mode which allows the user to obtain another product without having to go through the payment module or to obtain another product in the case where the product is stuck or defective. The company that owns the vending machines can also sell products to the hospital, for its own internal needs, by remotely releasing the ordered products and billing the hospital later on. This aspect is of particular importance since the present invention is to be used mainly in hospitals and health care centers. Therefore, articles sold through the present machine are generally much more expensive and generally immediately needed by the customer whereas articles sold by prior art machine (e.g. soda, snack, candy, etc.) are usually cheap and superfluous. Hence, in the current invention, it would be inadmissible that a customer be prevented from obtaining the product or products he or she has bought. The remote ejection mode is thus used by an administrator of the machine to provided another product when the initially bought product is defective or stuck in the machine.

The remote retrieval of sales data allows to the administrator of the vending machines to recuperate his/her sales data at the frequency and the time of his/her choice in a useful, secure and quick way, without having to move, thanks to the use of the communication network and of the software which are part of the present invention.

The software which is installed on each vending machine's computer system, which is part of the present invention, preferably comprises a filling sub-system to be used with a bar code reading pen. This device enables a faster filling with one stroke of the pen. Previously, the code of each compartment had to be entered one by one.

It is also possible to use remote initialization means for a vending machine which allows the set up of the data system relative to the inventory of a new vending machine. The management system also makes it possible to change this inventory at any time, whether for one product or for the entire content of the vending machine and that, without wasting a lot of time by having to recompile data in the network's database.

Remote compartment modification means are also functionality associated to the system's management mode which offers the possibility to remotely change the compartment's configuration of the vending machine, according to the specifications of a product to be offered in the future. The system's networked database may be remotely modified and the confirmation of this modification will only go through when the technician will open the vending machine to perform a filling.

According to yet another aspect of the present invention, when the products to offer via a vending machine necessitate too much space, the use of the virtual compartment feature makes it possible to offer to the users the possibility to select merchandises physically located outside of the vending machine and then to pay the price using the “payment module” of the vending machine. This functionality also offers the opportunity to offer more products to the vending machine's users when the merchandise control becomes necessary for security reasons or because of the product's value.

The communication sub-system of the vending machine with the central server is unique and at the heart of the management system of this invention, because it makes it possible to know which vending machine fail(s) to meet the previously established condition for an acceptable inventory. Since each vending machine can send information bearing electronic signal in the preferred form of electronic messages, via the network, to the central system, this information becomes available to every technician and administrator of the network when it reaches a “critic mass” per compartment.

One of the applications installed on the computer system of the vending machine allows the users to have direct access, through a modem or other known means, to a banking system via a debit card, or to pay with a credit card or with cash, and also to offer the possibility to buy a plurality of products during the same transaction.

According to still another aspect of the present invention, the large multimedia screen can be used to display advertisements and/or product presentations when the machine is idle.

### BRIEF DESCRIPTION OF THE FIGURES

FIG. 1 shows a front view of a vending machine incorporating the invention.

FIG. 2 schematically illustrates the links between the different components of a network according to the invention.

FIG. 3 shows a partial view of a computer system installed inside the vending machine shown in FIG. 1.

FIG. 4 shows an example of an interface of the management software for the remote management options, as seen from the computer terminal.

FIG. 5 shows an example of an interface of the remote management software to connect to the server, as seen from the computer terminal.

FIG. 6 shows an example of an interface of the remote management software to modify the vending machines' configurations, as seen from the computer terminal.

FIG. 7 shows an example of an interface of the communication software as seen from the computer terminal.

FIG. 8 shows an example of an interface of the communication software as seen from the vending machine's screen.

FIG. 9 shows a schematic view of a portion of the vending machine's computer system.

### DETAILED DESCRIPTION OF A PREFERRED EMBODIMENT

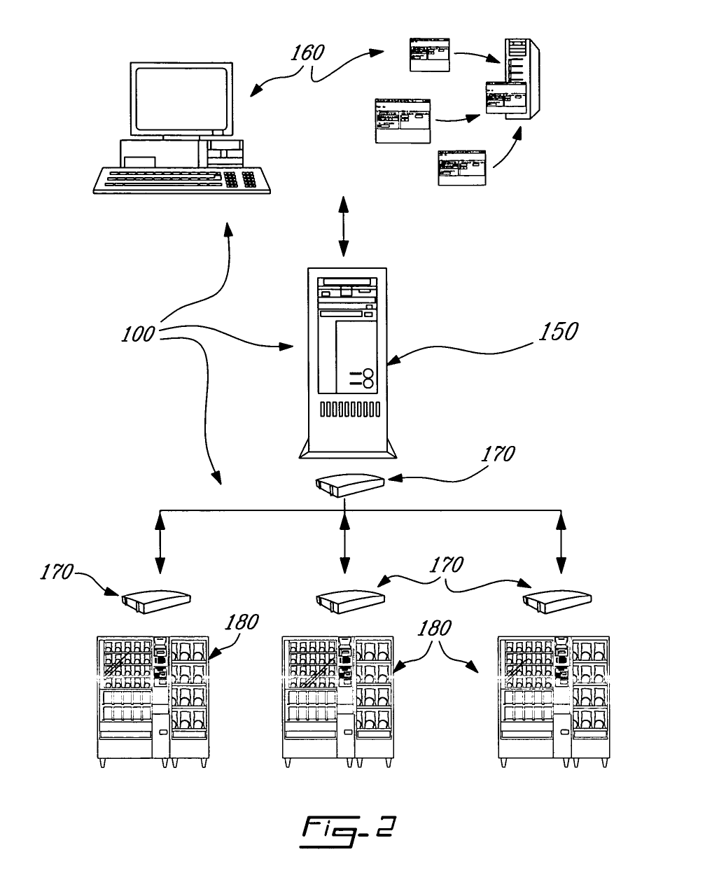

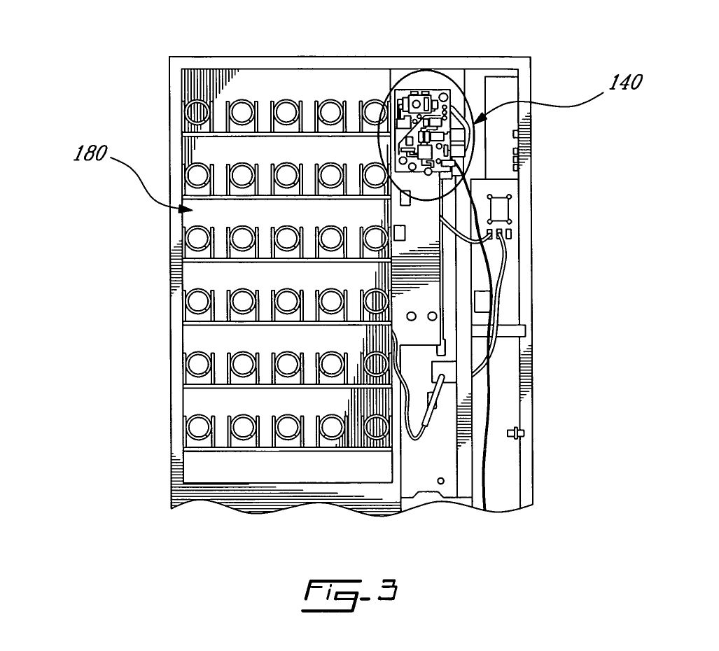

The system presented in this invention and schematically shown in FIG. 2 comprises a computer network 100 linking together in a network, through modems (or other network interfaces) 170, at least one server 150, at least one and preferably a plurality of vending machines 180 and administrator computers 160 which are installed as required by the administrator. The system comprises a database located in the memory of the server 150, administration or management softwares and communication softwares and also, vending machines 180 equipped with computer systems 140 comprising in their memory tables the copy of their inventory, as shown in FIG. 3.

Preferably, the computer terminals 160 are equipped with remote management software and remote communication software and vending machines 180 are equipped with local management software and local communication software. These management softwares allow for the management of the different data processed by the computer terminals 160 and the vending machines 180. The communication softwares allow for the effective communication between the computer terminals 160, the server 150 and the vending machines 180.

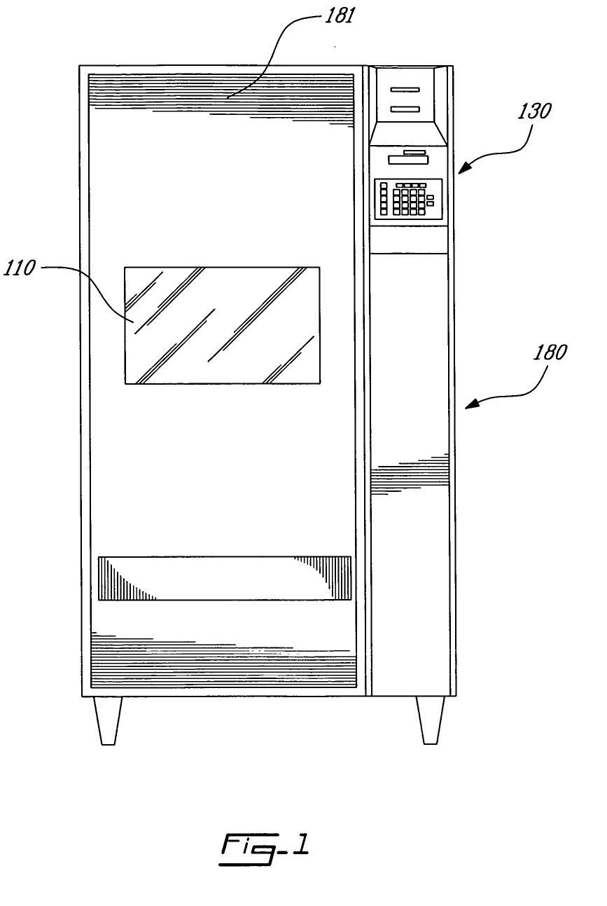

FIGS. 1, 3 and 9 show an embodiment of a vending machine 180 and of its computer system 140 which offers a variety of products with simple and interactive operating methods sending messages to the users, to the technicians and to the administrators of the vending machine 180.

As shown in FIG. 1, the vending machine 180 of the present invention comprises a large display screen, preferably located on the access door 181 of the machine 180. The screen 110 of the vending machine is preferably a LCD or plasma screen but any type of generally flat screen could be used. Moreover, the screen 110 is a touch screen. Thus, the screen 110 is the interface between the user and the machine 180.

When the vending machine 180 operates, it displays on the screen 110 a message requiring the entry of a user code. This user code is entered by typing on the screen 110 on the virtual keyboard which is displayed on the screen 110. The numbers and/or letters corresponding to the code and each entered number/letter can be displayed on the screen 110 because of the connection 143 to the computer system 140. This code makes it possible to know if the user is authorized to use the vending machine 180. After the user has entered his code, the vending machine's 180 micro-controller 144 verifies the correspondence between the entered code and a code which can be found in the memory table 141 of the computer system 140 which contains all the valid codes. If the code is invalid, the micro-controller 144 will preferably display an error message on the screen preferably inviting the user to contact an administrator. The micro-controller 144 will then reset and go back to its starting menu. If the code is accepted, the micro-controller 144 goes to a second interactive menu.

The skilled addressee will understand that other ways to provide an entry code such as a magnetic card, a smart card, a RFID tag, etc. are also contemplated.

One of the interesting aspect of the present invention is that, contrary to prior art system, the screen 110 of the machine 180 can display, in the form of thumbnail pictures, the actual content of the machine 180. Thus, when the machine 180 is in the second menu, it preferably displays small pictures of all the products available through the machine 180. It can also display the actual inventory of each product. Also, should a production be sold-out, the sold-out product could be marked as such so that the customer knows that he or she cannot buy that particular product.

During the selection stage, the vending machine's 180 micro-controller 144 will thus display on the screen 110 a picture and a short description of all the products and a message asking the user to select one or many selections. The selections are made by touching a particular picture of a product on the screen 110. The machine may also sell product which are not actually located inside the machine due to size or security measures. These products are known to be located in virtual compartments of the machine. The compartments are <<virtual>> in the sense that they are not located within the vending machine 180 itself. They are also referred to as external compartments. For the purposes of this application, <<external compartment>> includes shelving, pigeon holes, boxes, closets, cabinets, cupboards and the like.

When the user touches one picture, a third menu appears showing a larger picture of the product with an accompanying more detailed description and preferably the actual inventory for the particular product. To actually add a product to the current transaction, the user may use a plus (and/or minus) virtual button or a virtual keypad comprising numbers. When the user has finished selecting the current product, he goes back to the second menu to select another product.

As the user selects products, the selections are stored in the memory table 142.

When the user has finished selecting products, he can proceed to check-out by touching the check-out virtual button on the screen 110. Prior to displaying the check-out menu, the micro-controller 144 will retrieve all the selections from the memory table 142. The micro-controller 144 will then compute the total price by multiplying the selected quantity of each selected product by its unit price which is also retrieved from the memory table 142. The total cost is then computed by the micro-controller 144. The micro-controller 144 will then display on the screen 110 a summary of all the selected products with the quantity actually selected and the total price of all the selections. The user thus has a global view of the transaction prior to actually paying.

From the summary menu, the user may then go back to the selection menu to select more products, to remove certain products or reduce the quantity of certain selected products. If the user is satisfied with his selection, he can proceed to the payment menu.

It is also contemplated to display the total price after each selection (in the corner of the screen 110 for example) in order for the user to know on a constant basis the total cost of his selected products.

In the payment menu, the screen 110 displays a virtual button for each possible method of payment (cash, debit, credit, etc.). The user then touches the preferred method of payment. Depending on the choice of the user, the micro-controller 144 will send that appropriated signals to either the banknote reader 159 or the card reader 153 of the payment module 130.

In the event that the user chooses a credit or debit form of payment, the micro-controller 144 then builds the request to send to the integrated banking module or card reader 153 via a connection 149 to the vending machine's 180 computer system 140. This request comprises many parameters. The most important parameters are each product's description, the cost of each product and the total amount of those products. Once the banking module 153 receives the request, it sends an acknowledgment of receipt back to the micro-controller 144, and the banking module 153 starts the transaction by asking the client to insert his credit or debit card and his personal identification number in the case of a transaction with a debit card. The banking module 153 communicates to a banking terminal via a modem 170 and waits for the transaction's approval. During the approval process, the screen 110 may display a waiting or other similar messages. When the approval is received by the banking module 153, this one sends the approval back to the micro-controller 144. The date and hour of the transaction is part of the approval.

In the event of a cash payment, a banknote reader 159, integrated in the payment module 130 of the vending machine's 180 computer system 140 via a connection 155, allows the micro-controller 144 to manage the transaction by itself. When the given amount is equal to the required amount, the micro-controller 144 also issues an approval.

That information is kept in memory to later be able to add it to a memory table 142 comprising the sales data. When the approval is sent to the micro-controller 144, the payment module 130 sends the transaction to the printer which executes the printing because of the computer system's 140 printer connection 156. During printing, the receipt and/or voucher containing the relative information regarding the paid amount and the user's selected products can also be formatted, for instance, such that it can reference a prescription in the case where the user must acquire medical supplies and that the receipt has to be presented to his/her insurance. During the printing, the display screen 110 may display a “printing” or other similar messages. Once the printing is over, the micro-controller 144 goes to the next menu regarding the product ejections.

To eject a product, the computer system's 140 micro-controller 144 communicates with the vending machine's 180 motor controller 147. Once the product has been ejected, the motor controller 147 sends back to the micro-controller 144 the information stating that the product has been correctly ejected. The micro-controller 144 follows this step until all the selections are ejected.

Since products located in virtual compartments cannot be ejected, they must be obtained by other means. Preferably, if one of the selection is a product located in a virtual compartment, the printed bill will also contain a voucher indicating that the product has been paid for. Thus, the user may go to a storage room to pick up his product or may go to a counter wherein he can exchange his voucher against the product.

When all the selected products are ejected, the micro-controller 144 goes to the inventory update menu. To perform its inventory update, the micro-controller 144 must find the available quantities of each product in a memory table 142 and then decrements the quantity of each selected product by the quantity that has been ejected (or sold for products in virtual compartments). Once the update is finished, the micro-controller 144 verifies via its memory table 142 if the new updated quantities have reached their critical quantities which have been determined by the administrator beforehand. If one of the selections has reached its critical quantity and the inventory is insufficient, the micro-controller 144 indicates to its memory table 142 that an electronic message will have to be sent subsequently.

To perform the update of the sales table, the micro-controller 144 writes the actual sales data. This sales table can be found on the memory table 142 of the computer system 140. Each sale is detailed in this memory table 142 and comprises, among other things, the user code of the person who made the transaction, the identification of each compartment from which a sale was made, the time and date of the transaction and the batch and sequence numbers which were given by the payment module 130 at the time of the transaction.

The last step associated to the functioning of the vending machine 180 for a transaction involving a user concerns the sending of electronic messages by the computer system's 140 micro-controller 144 in the vending machine 180, in the case where after a sale, a compartment reaches its critical quantity which was determined by the administrator beforehand. This message contains the identification of the vending machine 180 which sends the message, the identification of the compartment (real or virtual) which has reached its critical quantity level and the quantity still left in its inventory. Once the message has been constructed, the micro-controller 144 initiates a modem 170 or any other type of communication with the server 150 of the network 100. Once the connection is established the micro-controller 144 transmits the message to the server 150 and then ends the communication. Once the message has been sent, the micro-controller 144 goes to its main menu and the screen 110 displays a message inviting a user to use the machine 180.

On top of offering an innovative operating system in the field of vending machines 180, this invention also uses management modules destined to the network 100 administrators, which offer a range of functionalities allowing, among other things, the remote management of vending machines 180 and of their inventory, and also of the server's 150 database via a modem 170. All the relevant information which identifies each vending machine 180, their compartments and their virtual compartments are kept in memory, saved on the server 150 of the network 100 after the initialization of each vending machine 180 and before they start their service.

The remote ejection mode allows an administrator to remotely connect to a vending machine 180 in order to eject a product. The reasons requiring the use of a remote ejection feature comprise the need to release a product which is stuck or defective without having to go through the billing system or the need to provide products to the hospital or a health provider for its internal use, by remotely releasing the required products and bill the hospital or health provider for them afterwards.

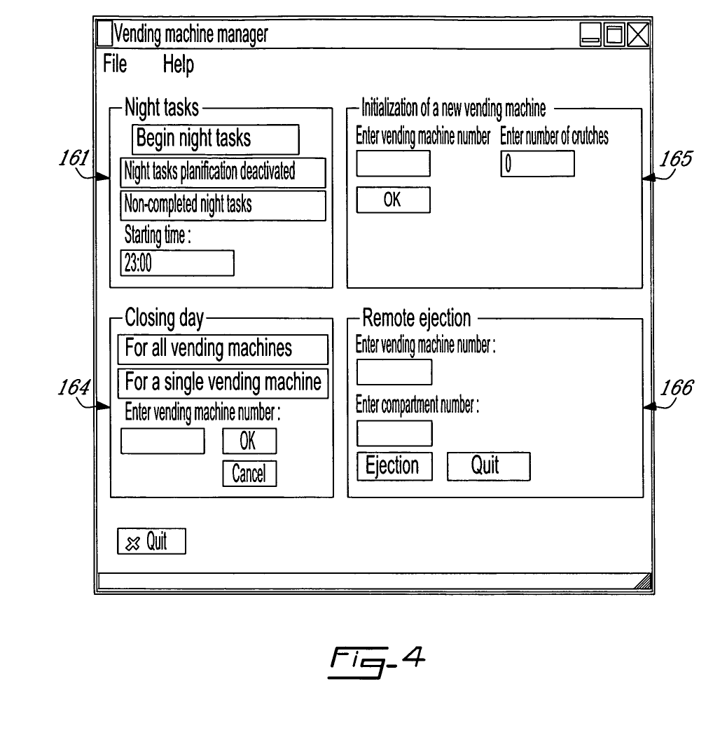

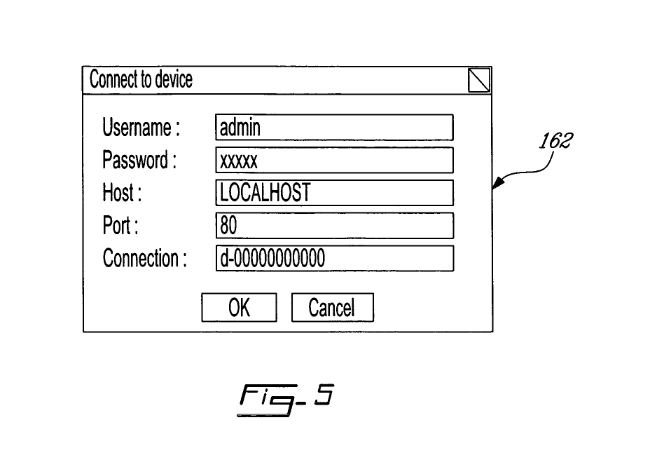

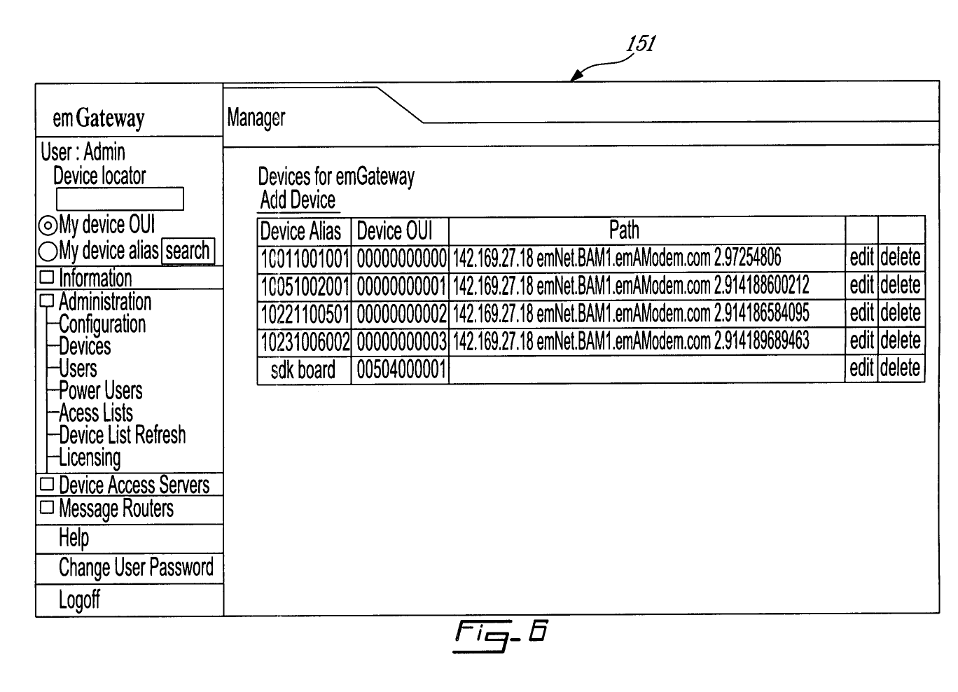

As shown in FIGS. 4, 5, 6 and 9, the remote ejection starts by accessing the administration software by its interface 162 which is installed on any computer linked to the network 100. The user asks for a connection with the help of the identification of the vending machine's 180 with which a communication is desired and via the ejection interface 166. The software then verifies the validity of the vending machine's 180 ID. If the ID is valid, the software initializes a communication with the vending machine 180 through the server 150 and the network 100. Once the connection is established, the administrator enters the compartment identification he/she wishes to activate and the software sends that information to the vending machine 180. The vending machine's 180 micro controller 144 sends to the motor controller 147 the command concerning the compartment ejection and then writes in the sales memory table 142 the required information. Once the sale has been recorded, the connection is shut. A camera (not shown), integrated to the vending machine's 180 computer system 140 via a connection 157 can also be used by the administrator, allowing him/her to judge by himself/herself the necessity to proceed with the remote ejection when a product is stuck in the vending machine 180. The image generated by the camera is therefore transmitted in one of the applications comprised on the computer terminal 160 of the administrator.

The remote sales data retrieval feature allows updating the inventory of the vending machines 180 and of the server's 150 database of the network 100. First, the administrator must chose on the “closing day” interface 167 (manually operated) or on the automatic interface 161 if he/she wants to recuperate the sales data, of only one or of a group of vending machines 180. If the choice is for only one vending machine 180, the administrator must enter the identification of the vending machine he/she wants to reach. The administration software then initiates a connection with the vending machine 180 and then sends to its micro-controller 144 the command of sales data retrieval or download. The micro-controller 144 then sends all the sales data recorded in its memory table 142 from the last sales retrieval and then sends it to the administration software which then builds a file containing all the sales data. In that sales file, one line per sale comprises different information relative to the sales and it is used in order to add the sales in the server's 150 database. The administrator also has the choice to retrieve the sales data for a particular group of vending machines 180 by establishing a communication with each one of them, one at a time, the same way than for the way it is described for a single vending machine 180.

In a typical operation of this system, the remote fillings or replenishment data retrieval or download sub-system then serves to identify, during the same established connection between the administrator's computer and the vending machine 180, if there was any filling made in any of the vending machines 180. When the software finishes retrieving the sales data, the software goes to the remote fillings or replenishment data retrieval mode. In this mode, the administration software asks to the vending machine's 180 micro-controller 144 if there was any filling made since the last connection. If that is the case, the micro-controller 144 transfers to the administration software the data regarding the fillings. The transferred data is done for each compartment, including the quantities before and after the filling and the actual quantity. With the data, the administration software builds a file containing all the information which will be used by the database to update its inventory.

The remote compartment modification sub-system allows the modification of one or more compartments in the vending machine 180, thus permitting price modifications, the modification of the maximal quantity in a compartment, the modification of the critical quantity of a compartment or the modification of the product's description in a compartment. The way to modify a compartment consists in opening the server's 150 database and proceeding with the required changes via the modification interface 151 of a vending machine 180. Then, when the administrator proceeds with the sales data retrieval with the administration software, the software verifies if there were compartment modifications on the vending machine 180 to which it is connected. In this mode, the administration software transfers or uploads compartment modification data to the vending machine's 180 micro-controller 144, the compartment modification data comprise the changes to make to the compartments. If the modification to a compartment consists in replacing one product for another, which corresponds to a change of a product's description, the micro-controller 144 keeps this change in memory and at a filling, this modification will be carried out by specifying to the micro-controller 144 that the compartment's modification has occurred. If a compartment's modification does not necessitate a change of product, the modification is effective right away, without anybody's intervention.

This stage normally ends the succession of operations made by an administrator during the same connection with a vending machine 180, in order to allow him/her an accurate control of the inventory.

Other management functionalities allow this invention to offer a management system which was not previously available on the market. Indeed, the remote initialization sub-system of a vending machine 180 allows the transfer or upload of an initial or new inventory data to a vending machine 180. This sub-system is mostly used at the introduction stage of a new vending machine 180 by permitting to the administrator to automatically initialize a configuration with the requested products.

The way to proceed with a remote initialization of a vending machine 180 starts with the addition of the vending machine 180 in the database via the modification interface 151, and with the definition of each of the compartment's content for this vending machine 180 according to the needs of the hospital or other users. When the vending machine 180 is created in the database, the administrator opens the administration software and starts an initialization via the initialization interface 165.

To start an initialization, the administrator must enter the vending machine's 180 identification which he wants to initialize. Then, the software verifies with the database if the vending machine's 180 identification exists. If it is the case, the administration software starts a communication with the requested vending machine 180 and then transfers all the necessary data for its initialization. The transferred data includes all the initial inventory data of the vending machine, comprising each product's description, their price, the maximal quantity of each of them and their critical quantity. The software also transfers all codes of the users having access to the vending machine. The software also initializes some tables and variables to ensure a good functioning of the vending machine 180. Then, when all the tables of the vending machine 180 are initialized, the administration software ends its connection with the vending machine which is now ready to be used.

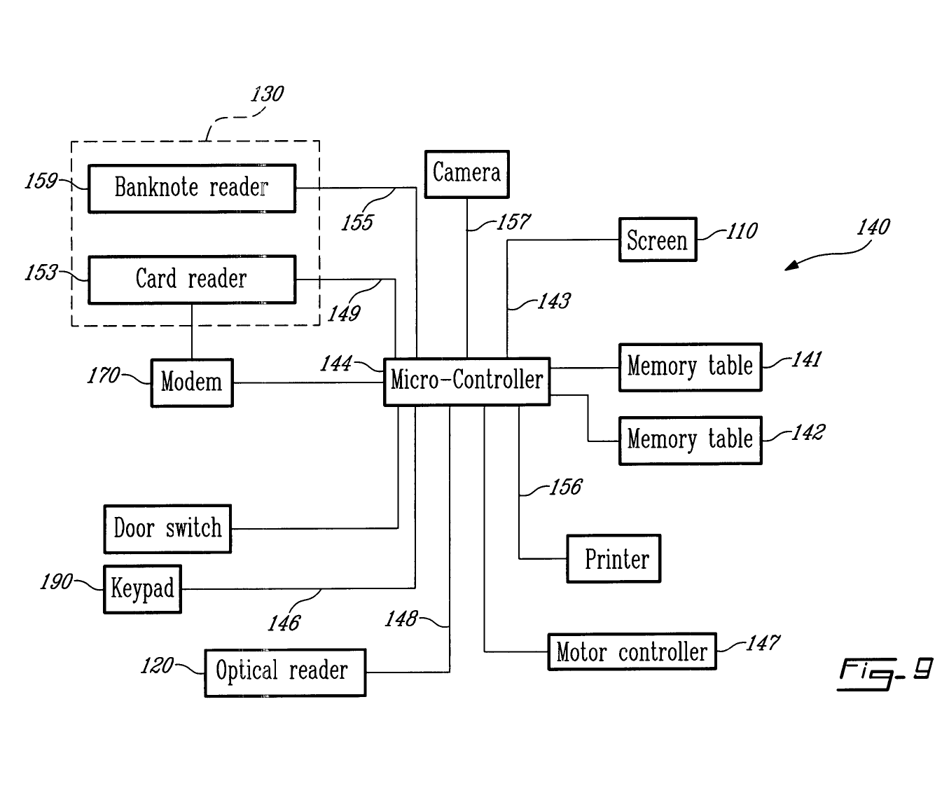

It is also possible to make a filling of a vending machine 180 with the help of an optical reader 120 and bar codes. Each compartment of the vending machine 180 has a corresponding bar code. Other bar codes are also available for other options. When a filling has to be made, the first step consists in opening the vending machine's 180 door. At that time, the micro-controller of the vending machine 180 goes to a filling mode via a switch door connector 145 (FIG. 9) and send a message to the vending machine's 180 screen 110 asking the technician if he/she wants to fill, repair or change a compartment in the vending machine 180. If it is a repair, the technician must touch the reparation virtual button, proceed with the necessary repairs and close the door. If it is a filling, the filling virtual button must be touched on the screen 110.

After touching the virtual button allowing the filling, the micro-controller 144 assumes that everything is full in the vending machine 180 as a default value. If during the filling, some of the compartments are not to their maximal quantity, the person doing the filling procedure must read the bar codes of each compartment to adjust the exact quantity. When reading a bar code corresponding to a compartment, the micro-controller 144 adjusts to the new quantity. When all the compartment's quantities are appropriate, the person has the choice of ending the filling procedure or touching the virtual button which permits him/her to change products in order to proceed with the compartment's modification.

When there is a previously introduced change of products in the database by the system administrator, the vending machine 180 is made aware of this modification via the administration software. When touching the virtual button allowing the modification, the micro-controller 144 asks in which compartment he/she desires to make the modification. At that time the user must read the bar codes corresponding to the number of the compartment to change. If the compartment number is valid, the computer system's 140 micro-controller 144 of the vending machine 180 proceeds with the change in its memory tables 142. Then, the technician has the choice of continuing with or ending the changes. After the touching the ending button, the micro-controller 144 indicates that the user must close the door to end the filling. When the door is closed, the vending machine 180 goes back to its normal mode, waiting for a transaction.

On each vending machine 180, the administrator has the possibility to add virtual compartments. The external compartments correspond to compartments of a vending machine 180, but they are however physically located outside of the vending machine 180. The external compartments offer the possibility of distributing products which cannot be located inside the vending machine (e.g. crutches). Also, they allow at the same time to increase and to control more strictly the inventory managed by a vending machine 180. When a vending machine 180 manages virtual or external compartments, a corresponding thumbnail picture is presented and available in the selection menu. After touching the selected product, the micro-controller 144 gathers all the necessary information regarding this product in its memory table 142 to get the data concerning its inventory.

All those functionalities in this invention regarding the operating and management system are made possible via a bi-directional communication mode between the vending machines 180 and the server 150. The communication protocol is carried out via a modem 170 or other known network and communication means. Therefore, with the introduction of this communication means, it is possible to develop applications for personal computers, allowing to perform various remote operations on a vending machine 180. Moreover, an administrator could send a specific message to be displayed on the screen 110 of a particular machine. For example, if a new product is now available, the administrator could send a small presentation to be displayed on one or a plurality of machines 180 when the machines are in idle (waiting for a transaction).

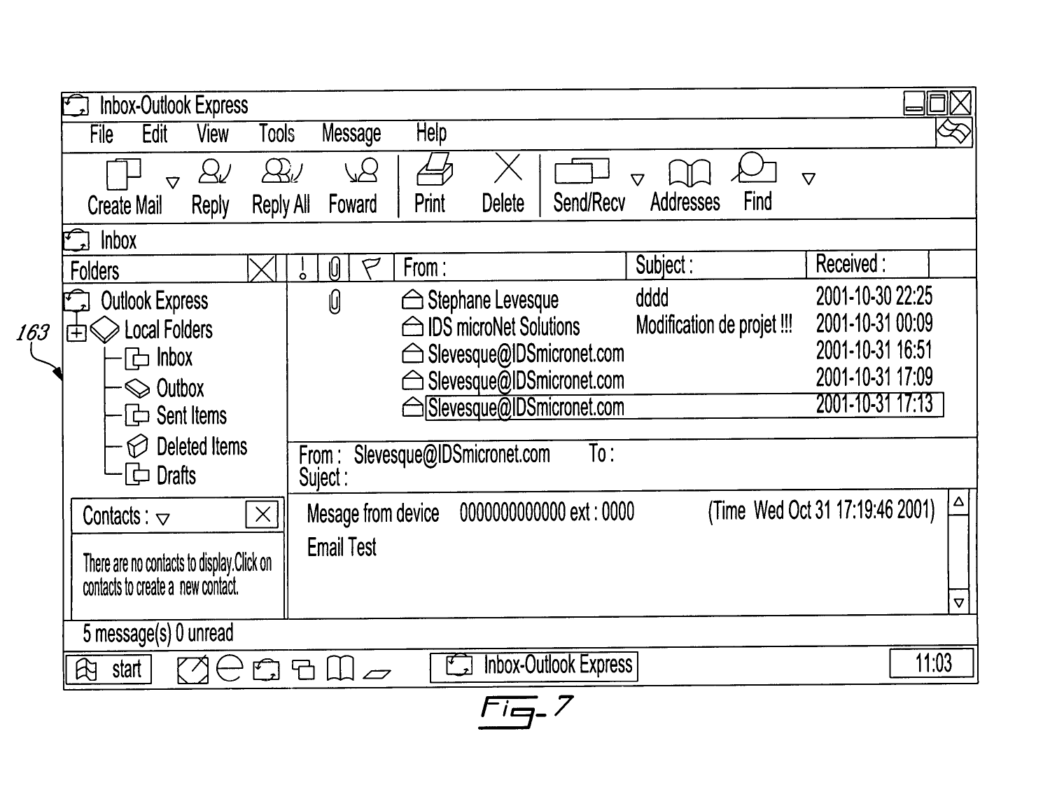

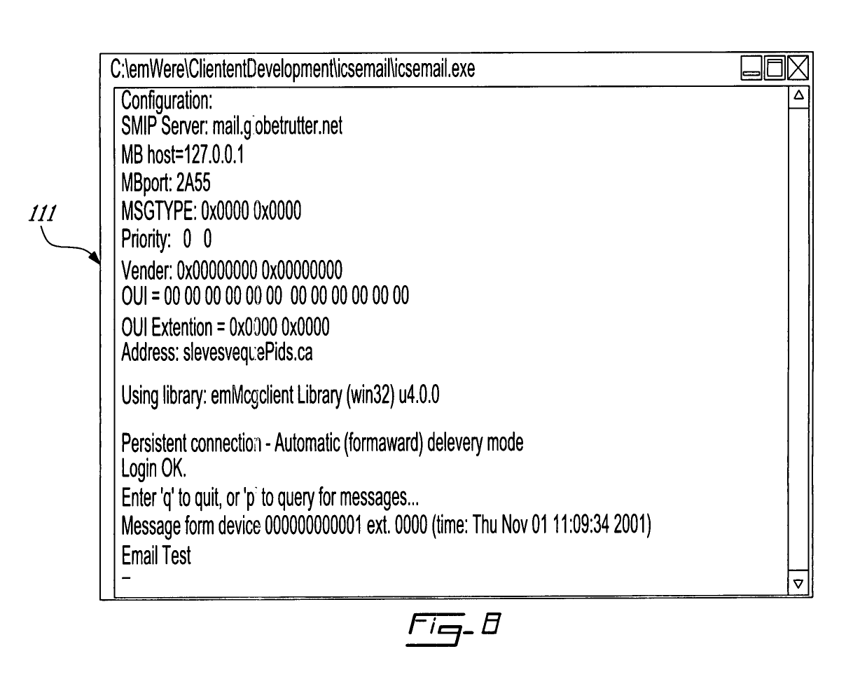

This technology also allows the sending of electronic messages via a communication software. At the installation of the server 150, a message database is created and comprises the messages that the vending machines 180 send and can decipher. With this database, a communication software installed on the vending machine's 180 computer system 140 and on the administrator computer 160 can therefore look for new messages received in this database and also send some to specific addressees via electronic mail. As illustrated in FIGS. 7 and 8, the administrator's mail interface 163 and the one of the vending machine 111 allow the sending of messages between the various interveners inside the network 100. Therefore, by developing the vending machine's 180 communication software, one can specify various factors for which the result could be the sending of an electronic message. For instance, if a sale has been made and the critical quantity has been achieved, the vending machine 180 then initiates a communication with the server 150, transmits the message to the server 150 which then puts this message in a database, the communication software gets the message and transfers it to the requested addressees.

Moreover, the computer system 140 of each machine 180 may also be equipped with at least one and preferably a plurality of input/output ports such as but not limited to USB ports, serial ports, parallel ports, etc. With such ports, it would be possible for a technician to connect a keyboard 190 to the machine 180 in order to modify the description of a product for example. A media player (not shown) could also be connected to the micro-controller 144 via one of the port. The media player could be used to upload software upgrades or product presentations for instance.

Also, a laptop or other multimedia player might be connected to the machine 180 computer system 140 in order to use the screen 110 as a presentation screen during formation or product presentation.

Furthermore, audio input and output such as a microphone and speakers could be added to the machine 180 to help sight impaired customers.

Although a preferred embodiment of the invention has been described herein, it should be apparent to those skilled in the art that variations and modifications are possible without departing from the spirit of this invention. For example, the described interface uses a keyboard. Other modes of data entry or selection like a mouse, a tactile screen or vocal commands could be used without changing the invention.

1. A computerized vending machine for distributing non-food articles, said machine comprising:
a. a micro-controller;
b. memory storage means in electronic communication with said micro-controller, said memory storage means comprising at least one memory table, a local management software and a local communication software;
c. a network interface in electronic communication with said micro-controller, said network interface adapted to communicate with a network;
d. a payment module in electronic communication with said micro-controller and in electronic communication with said network interface;
e. a display screen adapted to display multimedia content, said display screen being in electronic communication with said micro-controller, said display screen being reactive to contact;
wherein selection of said articles is effected by contacting said display screen.

2. A computerized vending machine as claimed in claim 1, wherein said machine further comprises at least one input and/or output port in electronic communication with said micro-controller.

3. A computerized vending machine as claimed in claim 1, wherein said machine further comprises a plurality of input and/or output ports in electronic communication with said micro-controller.

4. A computerized vending machine as claimed in claim 1, wherein said display screen is adapted to display at least one interactive menu.

5. A computerized vending machine as claimed in claim 4, wherein said at least one interactive menu comprises at least one graphical representation of a button, said at least one interactive menu being reactive to at least a partial physical contact between a user and said at least one graphical representation of a button.

6. A computerized vending machine as claimed in claim 1, wherein said local management software is adapted to manage articles located outside said machine.

7. A computerized vending machine as claimed in claim 1, wherein said memory table contains at least an inventory of said articles and wherein said display is adapted to display said inventory.

8. A computerized vending machine as claimed in claim 1, wherein said multimedia content further comprises advertisements and/or product presentations.

9. A computerized vending machine as claimed in claim 1, wherein said machine comprises a plurality of compartments.

10. A computerized vending machine as claimed in claim 9, wherein a machine-readable identifier is associated with each said compartments and wherein said machine further comprises a reader adapted to read said machine-readable identifier, said reader being in electronic communication with said micro-controller.

11. A computerized system for distributing non-food articles, said system comprising:
a. a least one computerized vending machine adapted to distribute said articles, said at least one vending machine comprising:
i. a micro-controller;
ii. memory storage means in electronic communication with said micro-controller, said memory storage means comprising at least one memory table;
iii. a network interface in electronic communication with said micro-controller, said network interface adapted to communicate with a network;
iv. a payment module in electronic communication with said micro-controller and in electronic communication with said network interface;
v. a display screen adapted to display multimedia content, said display screen being in electronic communication with said micro-controller, said display screen being reactive to contact;
b. a server comprising a source database, said database comprising:
i. data concerning all said articles distributed by said at least one vending machine;
ii. data relative to the authorizations of different users, administrators and technicians who can access said vending machine;
iii. data relative to the authorizations of different administrators who can access said server;
c. at least one computer terminal linked to said server, said computer terminal comprising a remote management software and a remote communication software, said remote management software allowing remote controlled operations on said server and/or on said vending machine;
d. communication means linking together said vending machine, said server and said computer terminal in a network;
wherein said computer system of said at least one vending machine is adapted to send and receive information bearing electronic signals to and from said computer terminal via said communication means and wherein said computer terminal is adapted to send and receive information bearing electronic signals to and from said vending machine via said communication means.

12. A system as claimed in claim 11, wherein said local management software of said computer system of said at least one vending machine is adapted to verify the availability of said selected articles with an inventory file located in said memory tables.

13. A system as claimed in claim 11, wherein a plurality of vending machines located in one or more different locations are linked together via said communication means and are remotely accessible via said computer terminal.

14. A system as claimed in claim 11, wherein a plurality of computer terminals located in one or more different locations are linked together via said communication means and are each able to remotely control one or more of said vending machines.

15. A system as claimed in claim 11, wherein said at least one vending machine comprises at least one compartment located inside said machine, said compartment being equipped with an ejection mechanism and wherein said remote controlled operations comprise means to remotely eject one of said articles from said at least one compartment of said at least one vending machine, said remote ejection being done via said computer terminal, said communication means, said micro-controller and said ejection mechanism.

16. A system as claimed in claim 11, wherein said information bearing electronic signals are sales data and wherein said remote management software is adapted to download and receive said sales data from said vending machine, said download of said sales data being done via said computer terminal and said communications means.

17. A system as claimed in claim 16, wherein said information bearing electronic signals are replenishment data and wherein said remote management software is adapted to download and receive sand replenishment data from said vending machine, said download of said replenishment data being done via said computer terminal and said communications means.

18. A system as claimed in claim 17, wherein said server is adapted to generate an inventory file by comparing said downloaded sales data and said downloaded replenishment data.

19. A system as claimed in claim 1, wherein said information bearing electronic signals are compartment modification data and wherein said remote management software is adapted to upload and send said compartment modification data to said vending machine, said upload of said compartment modification data being done via said computer terminal and said communications means.

20. A system as claimed in claim 1, wherein said information bearing electronic signals are initial inventory data and wherein said remote management software is adapted to upload and send said initial inventory data to said vending machine when said vending machine is being initialized, said upload of said initial inventory data being done via said computer terminal and said communications means.
